(19) United States
(12) Patent Application Publication
(10) Pub. No.: US 2026/0170388 A1
(43) Pub. Date: Jun. 18, 2026

(54) DYNAMIC QUANTUM RESOURCE ALLOCATION BASED ON QUANTUM RESOURCE AVAILABILITY

(71) Applicant: Red Hat, Inc., Raleigh, NC (US)

(72) Inventors: Leigh Griffin, Waterford (IE); Stephen Coady, Dublin (IE)

(21) Appl. No.: 18/983,853

(22) Filed: Dec. 17, 2024

(51) Int. Cl. G06N 10/80; G06N 10/20

(52) U.S. Cl. CPC G06N 10/80; G06N 10/20

(57) ABSTRACT

A computing system (e.g., a quantum computing system) can: obtain a quantum instruction set comprising a plurality of quantum operation instructions; identify a first quantum resource allocation instruction in the quantum instruction set, the first quantum resource allocation instruction instructing a first quantum computing system to allocate a first quantum resource to implement the plurality of quantum operation instructions; determine an unavailability condition of the first quantum resource at the first quantum computing system; based on the unavailability condition, determine an attribute constraint based on a performance characteristic associated with the plurality of quantum operation instructions; identify a second quantum resource that satisfies the attribute constraint to allocate to implement the plurality of quantum operation instructions; and modify the quantum instruction set based on the second quantum resource.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

### SUMMARY

The present disclosure provides for improved allocation relationships between quantum instruction sets and quantum resources of one or more quantum computing systems. More particularly, a quantum computing system can determine that a first quantum resource allocated by a quantum instruction set is unavailable. The system can identify a second (available) quantum resource at development time and/or at execution time based on attribute constraints associated with the first quantum resource. For instance, the attribute constraints can specify attributes, such as qubit architecture, material, operational parameters, or proximity to other qubits, based on performance characteristics learned during prior operation of the quantum system. The system can modify the quantum instruction set based on the second quantum resource such that the second quantum resource is allocated in place of the first quantum resource. In some cases, a plurality of quantum resources may be refactored to maintain positional dependencies across the plurality of quantum resources.

In one implementation, a method is provided. The method includes obtaining a quantum instruction set comprising a plurality of quantum operation instructions. The method includes identifying a first quantum resource allocation instruction in the quantum instruction set, the first quantum resource allocation instruction instructing a first quantum computing system to allocate a first quantum resource to implement the plurality of quantum operation instructions. The method includes determining an unavailability condition of the first quantum resource at the first quantum computing system. The method includes, based on the unavailability condition, determining an attribute constraint based on a performance characteristic associated with the plurality of quantum operation instructions. The method includes identifying a second quantum resource that satisfies the attribute constraint to allocate to implement the plurality of quantum operation instructions. The method includes modifying the quantum instruction set based on the second quantum resource.

In another implementation, a computing device is provided. The computing device includes a memory and a processor device coupled to the memory. The processor device is to obtain a quantum instruction set comprising a plurality of quantum operation instructions. The processor device is further to identify a first quantum resource allocation instruction in the quantum instruction set, the first quantum resource allocation instruction instructing a first quantum computing system to allocate a first quantum resource to implement the plurality of quantum operation instructions. The processor device is further to determine an unavailability condition of the first quantum resource at the first quantum computing system. The processor device is further to, based on the unavailability condition, determine an attribute constraint based on a performance characteristic associated with the plurality of quantum operation instructions. The processor device is further to identify a second quantum resource that satisfies the attribute constraint to allocate to implement the plurality of quantum operation instructions. The processor device is further to modify the quantum instruction set based on the second quantum resource.

In another implementation, a non-transitory computer-readable storage medium is provided. The non-transitory computer-readable storage medium includes executable instructions to cause a processor device to obtain a quantum instruction set comprising a plurality of quantum operation instructions. The executable instructions further cause the processor device to identify a first quantum resource allocation instruction in the quantum instruction set, the first quantum resource allocation instruction instructing a first quantum computing system to allocate a first quantum resource to implement the plurality of quantum operation instructions. The executable instructions further cause the processor device to determine an unavailability condition of the first quantum resource at the first quantum computing system. The executable instructions further cause the processor device to, based on the unavailability condition, determine an attribute constraint based on a performance characteristic associated with the plurality of quantum operation instructions. The executable instructions further cause the processor device to identify a second quantum resource that satisfies the attribute constraint to allocate to implement the plurality of quantum operation instructions. The executable instructions further cause the processor device to modify the quantum instruction set based on the second quantum resource.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a computing system according to one implementation.

FIG. 2 is a diagram depicting a process for dynamic quantum resource allocation based on quantum resource availability according to one implementation.

FIG. 3 is a flowchart of a method for dynamic quantum resource allocation based on quantum resource availability according to one implementation.

FIG. 4 is a simplified diagram of a quantum system according to one implementation.

FIG. 5 is a block diagram of a computing device suitable for implementing examples according to one implementation.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples and claims are not limited to any particular sequence or order of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B. The word “data” may be used herein in the singular or plural depending on the context. The use of “and/or” between a phrase A and a phrase B, such as “A and/or B” means A alone, B alone, or A and B together.

Quantum computing involves the use of quantum bits, referred to herein as “qubits,” which have characteristics that differ from those of classical (i.e., non-quantum) bits used in classical computing. Qubits may be employed by quantum services that are executed by quantum computing devices.

Quantum instruction sets, such as Quantum Assembly (QASM) files, are used to describe a service as sets of instructions that will be executed within a quantum device. Quantum instruction sets such as QASM files often include qubit reservations, qubit manipulations, gate manipulations, or the like. Classical computing systems and/or quantum computing systems generally need some way to manage multiple requests to utilize quantum computing systems, such as by simultaneous execution or a queue. For instance, it can be desirable to schedule an incoming quantum instruction set among a plurality of quantum computing systems and/or a plurality of other quantum instruction sets to facilitate orderly and optimized execution of the plurality of quantum instruction sets.

The present disclosure relates to dynamic quantum instruction set routing based on quantum resource availability. A quantum instruction set, such as a quantum assembly (QASM) file, includes instructions that can be executed by a quantum computing system to implement a quantum circuit. The quantum instruction set can describe requirements for quantum resources, such as qubits, that are ultimately used by the quantum computing system to implement the quantum circuit. For example, the quantum computing system can apply quantum gate operations to the quantum circuit to execute a quantum algorithm. Although quantum programming languages such as QASM may provide some level of abstraction between quantum hardware and quantum algorithms, quantum resources and quantum computing systems can have significant variability in execution quality, especially compared to some classical systems. Therefore, the allocation of quantum resources among multiple quantum instruction sets can have a significant impact on the execution of the quantum instruction sets. Furthermore, quantum programmers often designate quantum resource allocations within quantum instruction sets based on particular attributes of those quantum resources. When multiple quantum instruction sets compete for the same quantum resources during scheduling, it can be challenging to efficiently route and refactor the quantum instruction sets in a manner that provides efficient scheduling while also maintaining the execution quality of quantum instruction sets utilizing particularly-selected quantum resources.

The present disclosure provides systems and methods that can beneficially integrate with a development environment for quantum instruction set development. The systems and methods according to the present disclosure can interface with quantum resource availability data from quantum systems to convey real-time data regarding availability of quantum resources and load information of quantum services. For example, the systems and methods can convey information regarding which quantum resources (e.g., qubits) are consumed by which quantum services and/or which quantum resources are presently available for allocation. When generating a quantum instruction set or providing the quantum instruction set for implementation at one of a plurality of quantum computing systems, the systems and methods described herein can propose a refactored quantum instruction set when one or more of the quantum resources in the original quantum instruction set are unavailable that provides for improved performance (e.g., improved accuracy, reduced error, etc.) of the quantum computing system in executing the refactored quantum instruction set. For example, the refactoring can maintain optimal qubit position to provide proximity for multigate operations and/or use consistent qubit attributes (e.g., material types) even if the quantum resources are allocated across a plurality of quantum computing systems or are different from the quantum resources specified by the developer. This real-time allocation information can provide for modifying the quantum instruction set and/or for annotating the quantum instruction set (e.g., in an interface of the development environment) with allocations of selected quantum resources.

For instance, one example implementation can interface with a scheduler to routinely refactor a quantum instruction set that is queued for execution to match a current workload across a plurality of quantum systems. This approach can provide a continuous stream of refactored quantum instruction sets that are responsive to the present availability of the quantum resources at a point in time that is closest to execution of the quantum instruction sets. By minimizing the difference between designed quantum instruction sets and quantum instruction sets at the point they are sent for execution, the present disclosure can conserve computing resources associated with multiple refactorings of quantum instruction sets based on delayed availability or last-second changes to resource availability. Another example implementation can utilize machine-learning techniques to inform the grouping and integration strategy (e.g., at the design environment level).

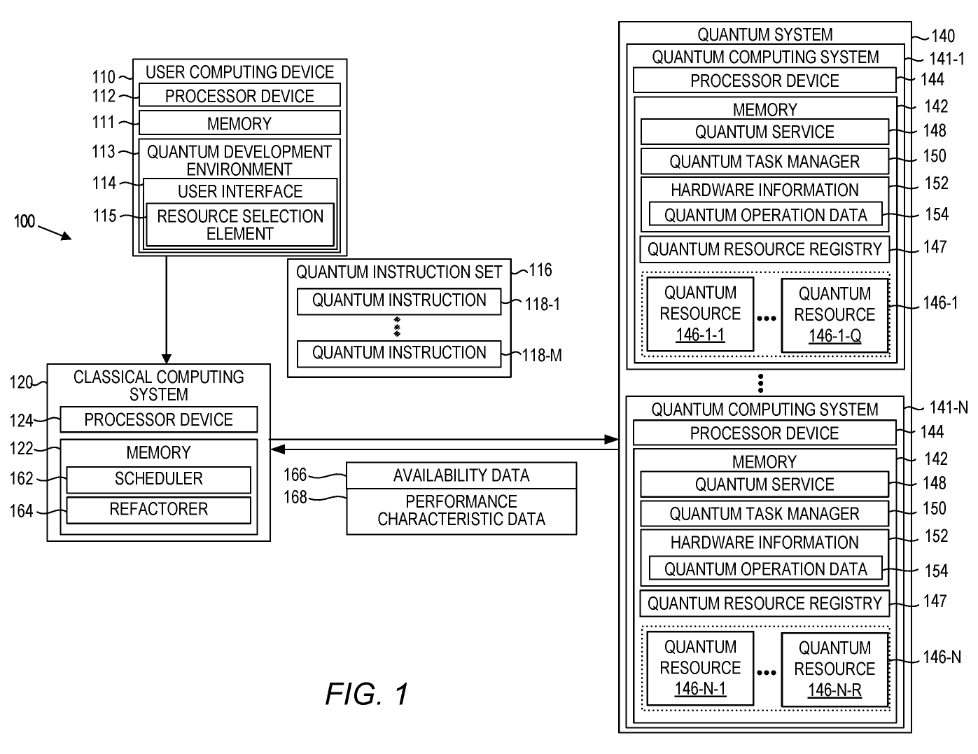

FIG. 1 is a block diagram of a computing system 100 according to one example. The computing system 100 includes a user computing device 110 coupled to a classical computing system 120 and a quantum system 140 including a plurality of quantum computing systems 141-1 through 141-N (generally referred to as quantum computing systems 141). The user computing device 110 can be a classical computing device including a memory 111 and a processor device 112 coupled to the memory 111.

The user computing device 110 can implement a quantum development environment 113. The quantum development environment 113 can provide a user (not illustrated) of the user computing device 110 with tools (e.g., via a user interface 114) to perform operations or indications described herein. As one example, the quantum development environment 113 can receive user input and generate quantum instruction sets 116 based on the user input. For example, the quantum development environment 113 can provide for a user to design, specify, or otherwise generate a quantum instruction set 116 and/or a plurality of quantum operation instructions 118-1 through 118-M (generally referred to as quantum operation instructions 118). The user interface 114 can include a resource selection element 115.

The classical computing system 120 can provide the quantum instruction set 116 from the user computing device 110 to the quantum system 140. The classical computing system 120 can include a memory 122 and a processor device 124 coupled to the memory 122 to perform the operations described herein. In certain implementations, the classical computing system 120 includes functionality provided by the user computing device 110. The quantum instruction set 116 (e.g., the plurality of quantum operation instructions 118) can be implemented by one or more of the quantum computing systems 141 to perform a quantum algorithm. The quantum computing systems 141 can include a memory 142 and a processor device 144 coupled to the memory 142 to facilitate quantum computing operations as described herein. For instance, each quantum computing system 141 can include quantum resources 146 associated with (e.g., controlled by) the quantum computing system 141. For example, the first quantum computing system 141-1 can include a plurality of first quantum resources 146-1-1 through 146-1-Q through the Nth quantum computing system 141-N, which can include a plurality of Nth quantum computing system resources 146-N-1 through 146-N-R. To maintain information for the quantum resources 146, the quantum computing systems 141 may each include a quantum resource registry 147, which includes a plurality of quantum resource registry entries, each corresponding to a quantum resource 146. The quantum resource registry 147 maintains and provides access to data relating to the quantum resources 146 implemented by the quantum computing system 141, such as a count of the total number of quantum resources 146 implemented by the quantum computing system 141 and a count of the number of available quantum resources 146 that are currently available for allocation, as non-limiting examples. Each of the quantum resource registry entries of the quantum resource registry 147 also stores quantum resource metadata for a corresponding quantum resource 146. The quantum resource metadata may include, as non-limiting examples, an identifier of the corresponding quantum resource 146, an availability indicator that indicates whether the corresponding quantum resource 146 is available for use or is in use by a specific quantum service 148, an identifier of a quantum service 148 that is associated with the corresponding quantum resource 146 or to which the corresponding quantum resource 146 is allocated, and/or an entanglement indicator that indicates whether the corresponding quantum resource 146 is in an entangled state.

A quantum instruction set 116 may be implemented as a quantum service 148. The quantum computing system 141 executes one or more quantum services 148. The quantum service 148 is a process that executes on a quantum computing system 141 and employs quantum resources 146 to provide desired functionality. The quantum resources 146 can be, for example, qubits of the quantum computing systems 141. The quantum service 148 is defined using a quantum service definition, such as a quantum instruction set 116. For instance, the quantum operation instruction of the quantum instruction set 116 can be or can include qubit configuration instructions, qubit initialization instructions, gate operations, measurement instructions, and other suitable instructions that cause the quantum computing systems 141 to perform operations on or using the quantum resources 146. For instance, the quantum operation instructions 118 can instruct the quantum computing systems 141 to perform any of a variety of quantum operations, such as, for example, quantum resource allocation operations that reserve quantum resources 146 to implement a given quantum instruction set 116 as a quantum service 148 (e.g., to the exclusion of other quantum services 148) on the allocated quantum resource 146. The quantum instruction set 116 can be, for example, a Quantum Assembly Language (QASM) file. QASM is a programming language that specifies quantum circuits as input to a quantum computer by declaring classical bits and qubits and describing operations on the qubits and measurements needed to obtain a classical result based on the qubits.

Execution of quantum services 148 is facilitated by a quantum task manager 150, which handles operations for creating, monitoring, and terminating quantum services 148. The quantum task manager 150 may provide an interface (not shown) through which other services or tasks may request specific information regarding the quantum resources 146, the quantum service 148, and/or the quantum computing system 141. Additionally, information regarding the status and functionality of the quantum computing system 141 and the elements thereof may be made accessible to other processes via a hardware application programming interface (API) or other suitable interface.

Each quantum computing system 141 includes a physical enclosure containing quantum resources 146. Further, each quantum computing system 141 includes hardware information 152. Hardware information 152 may include load, operating temperature, noise, error rate, last time rebooted, hardware load, or the like. The hardware information 152 may be general or time-sensitive information. For example, the hardware information 152 may include load-based parameters, such as a low processing load threshold, a high processing load threshold, a low qubit usage threshold, a high qubit usage threshold, a low application queue threshold, a high application queue threshold, or the like. Hardware information 152 may include event-based parameters, such as low operating temperature threshold, high operating temperature threshold, or the like. Hardware information 152 may further include global operating parameters, such as a time, time period, processing load, available memory, count of executing processes, application queue, qubit usage, count of available quantum resources 146, and/or operating temperature, or the like. The hardware information 152 may include global operating conditions, such as system load, system response time, operating temperature, state of the qubits (e.g., qubit age, coherence time, and/or the like), or the like.

Accordingly, hardware information 152 may include quantum operation data 154, such as historical quantum operation data or current quantum operation data. The quantum operation data 154 may include, for example, processing speed, temperature, noise, error rate, hardware load, resource utilization, and/or qubit availability, or the like. The historical quantum operation data may provide generalized information about the general historical performance of the quantum computing system 141, such as whether the quantum computing system 141 typically operates at a high temperature. The current quantum operation data may provide time sensitive information of the quantum computing system, such as whether the quantum computing system 141 is currently operating at a high temperature.

According to example aspects of the present disclosure, the user computing device 110 and/or the classical computing system 120 can provide for dynamic allocation of quantum resources 146 based on real-time availability of the quantum resources 146 at the quantum computing systems 141. The classical computing system 120 can include a scheduler 162 that is to identify or select which quantum resources 146 to allocate for a quantum service 148 and a refactorer 164 that is to modify the quantum instruction set 116 to replace, annotate, or otherwise modify the quantum operation instructions 118 to indicate allocation of the identified quantum resources 146.

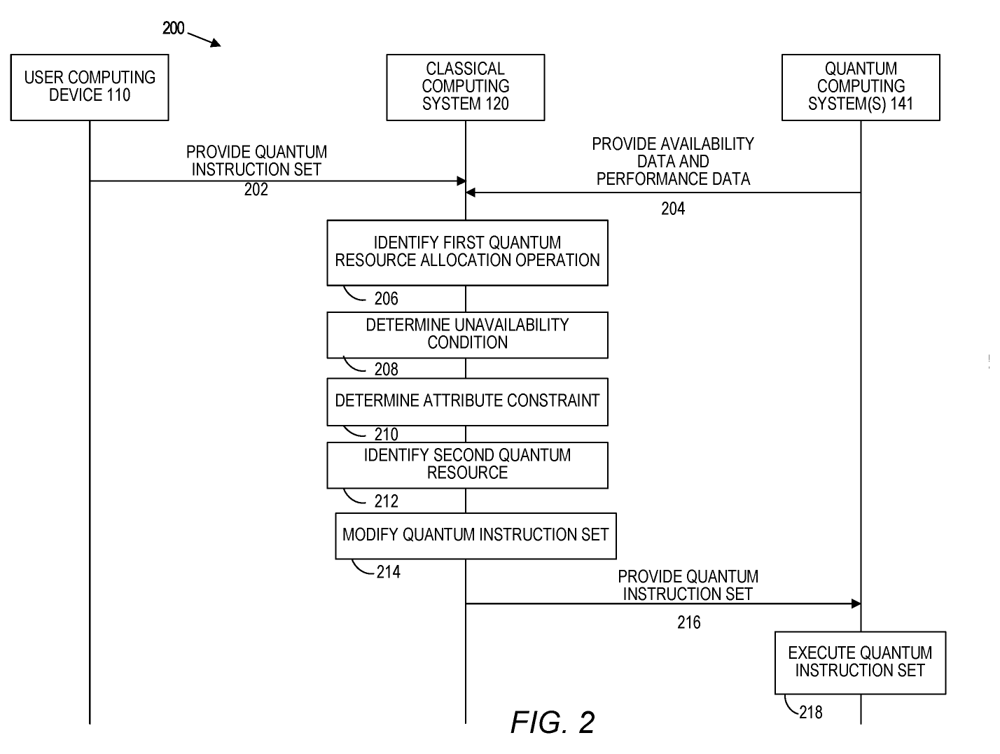

Operation of the user computing device 110, the classical computing system 120, and the quantum computing system(s) 141 will be discussed with reference to FIG. 2. FIG. 2 is a diagram 200 depicting a process for dynamic allocation of quantum resources. At 202, the user computing device 110 can provide a quantum instruction set 116 to the classical computing system 120. Furthermore, at 204, the quantum computing system(s) 141 can provide the quantum resource availability data 166 and/or the performance characteristic data 168 to the classical computing system 120.

In some implementations, the user computing device 110 can display, in the user interface 114 of the quantum development environment 113, the quantum instruction set 116 annotated with the quantum resource availability data 166 obtained from the quantum resource registry 147. For example, in some implementations, the resource selection element 115 can display a data item of the quantum resource availability data 166 associated with a particular quantum resource 146 in a proximate relationship with an identifier or other indicator of the quantum resource 146. For example, in some implementations, the resource selection element 115 can provide a list of delineated value pairs, where a first value of the value pair is or includes an identifier of the quantum resource 146 and a second value of the value pair is or indicates the availability of the quantum resource 146 having the identifier.

At 206 the classical computing system 120 can identify a first quantum resource allocation instruction in the quantum instruction set 116, the first quantum resource allocation instruction instructing a quantum computing system 141 to allocate a first quantum resource 146 to implement the plurality of quantum operation instructions 118. For instance, a quantum operation instruction 118 of the quantum instruction set 116 can be a quantum resource allocation operation instruction that instructs one of the quantum computing systems 141 to allocate or reserve one of the quantum resources 146 (e.g., a first quantum resource 146) for a quantum service 148 implementing the quantum instruction set 116.

At 208, the classical computing system 120 can determine an unavailability condition of the first quantum resource 146. The classical computing system 120 can determine the unavailability condition based on quantum resource availability data 166 from the quantum computing system(s) 121. For instance, the quantum resource availability data 166 can be representative of the real-time allocation status of the quantum resources 146 (e.g., as maintained by the quantum resource registry 147). The quantum resource availability data 166 may be identical to data at the quantum resource registry 147 and/or may be derived from data at the quantum resource registry 147 (e.g., a pruned version of the data maintained by the quantum resource registry 147).

At 210, based on the unavailability condition, the scheduler 162 can determine an attribute constraint based on a performance characteristic associated with the plurality of quantum operation instructions 118. In particular, the scheduler 162 can consider performance characteristics that are relevant to execution quality of the quantum service 148 implementing the quantum instruction set 116. In some cases, these performance characteristics can be relevant to the quantum instruction set 116 or the quantum instructions 118 themselves. For example, in some implementations, the performance characteristics can define a proximity constraint on two quantum resources 146 implementing a gate operation instruction of the quantum operation instructions 118. Furthermore, in some cases, these performance characteristics can be based on performance characteristic data 168 from the quantum computing systems 141. The performance characteristic data 168 can include historical, predetermined, and/or learned data on performance of given quantum operation instructions 118 on different quantum resources 146. For example, the performance characteristic data 168 can be or can be based on the quantum operation data 154 maintained by the hardware information 152. In some implementations, the performance characteristic can include expected performance data of the plurality of quantum operation instructions 118 respective to an attribute of the attribute constraint. The expected performance data can be learned from historical usage data associated with the quantum computing systems 141. For example, the performance data can include historical variations in performance of types of quantum instructions or operations across the different quantum resources 146, categorized by attributes such as qubit type, qubit material, proximity between two quantum resources 146 implementing a common gate operation, and so on.

At 212, based on the attribute constraint, the scheduler 162 can identify a second quantum resource 146. The attribute constraint can specify one or more of a material, a type, a configuration, or an operational parameter that is to be satisfied by the second quantum resource 146. to allocate to implement the plurality of quantum operation instructions 118. For instance, the attribute constraint can be a constraint on an attribute of the quantum resources 146 that must be satisfied for a quantum resource 146 to be identified as the second quantum resource 146. As one example, the attribute constraint can be a material type constraint that specifies a material type for the second quantum resource 146. As another example, the attribute constraint can be a proximity constraint that specifies a required proximity to an additional (e.g., available) quantum resource 146. The attribute constraint can further specify required attributes of this additional quantum resource 146. In some cases, the scheduler can identify a plurality of second quantum resources 146 to replace a plurality of first quantum resources 146 by associating an attribute constraint with multiple quantum resources 146 (e.g., to ensure consistent material selection across all refactorings).

In some implementations, the attribute constraint can define positional requirements between multiple quantum resources 146 utilized by the quantum instruction set 116. For instance, in some implementations, the quantum instruction set 116 further includes an additional quantum resource allocation instruction instructing the quantum computing system 141 to allocate an additional quantum resource 146 to implement the plurality of quantum operation instructions 118. For example, the plurality of quantum operation instructions 118 can include a quantum gate operation that is implemented by both the first quantum resource 146 and the additional quantum resource 146. The attribute constraint can be a proximity constraint on a relative position of the additional quantum resource 146 and the first quantum resource 146. Additionally and/or alternatively, the performance characteristic can be a latency of the quantum computing system 141 associated with a proximity of the first quantum resource 146 and the additional quantum resource 146. Furthermore, identifying the second quantum resource can include determining that a combination of the second quantum resource 146 and a second additional quantum resource 146 satisfies the proximity constraint and, based on determining that the combination of the second quantum resource 146 and the second additional quantum resource 146 satisfies the proximity constraint, identifying the second quantum resource for replacing the first quantum resource 146.

Furthermore, in some implementations, a user selection can be used to identify the second quantum resource 146. For example, in some implementations, identifying the second quantum resource can include receiving, by the resource selection element 115 of the user interface of the quantum development environment, a user selection of the second quantum resource 146. The user selection can be provided responsive to the display by the resource selection element 115 of the quantum resource availability data 166 of the quantum resources 146. The user selection can inform which of the available quantum resources 146 the user wishes to select, at the present time instance, for implementing the quantum instruction set 116.

At 214, the refactorer 164 can modify the quantum instruction set 116 based on the second quantum resource 146. For instance, the refactorer 164 can replace a first quantum resource allocation operation instruction that allocates a first quantum resource 146 (e.g., specified by a programmer) with a second quantum resource allocation operation instruction that allocates a second quantum resource 146 (e.g., identified by the scheduler 162).

In some implementations, modifying the quantum instruction set 116 based on the second quantum resource includes generating a second quantum resource allocation instruction for the quantum instruction set. The second quantum resource allocation instruction allocates the second quantum resource 146 for implementing the plurality of quantum operation instructions. For example, the second quantum resource allocation instruction can reference the second quantum resource 146 by identifier, memory address, or other means of identification such that, when the second quantum resource allocation instruction is implemented by a quantum computing system 141, the second quantum resource 146 is allocated for the quantum service 148. Modifying the quantum instruction set 116 can include replacing the first quantum resource allocation instruction with the second quantum resource allocation instruction.

Furthermore, in some implementations, modifying the quantum instruction set 116 can include utilizing a placeholder instruction in place of a true allocation operation instruction up until the quantum instruction set 116 is sent to a quantum computing system for implementation. For instance, the placeholder instruction may be used in tandem with an annotation indicating which quantum resource 146 would (or would likely) be allocated at that instruction. The placeholder instruction may not by itself by implementable by the quantum computing systems 141.

For instance, modifying the quantum instruction set based on the second quantum resource can include: generating a placeholder quantum resource allocation instruction; replacing the first quantum resource allocation instruction with the placeholder quantum resource allocation instruction; generating an annotation indicative of the second quantum resource; and annotating the quantum instruction set 116 with the annotation respective to the placeholder quantum resource allocation instruction. Annotating the quantum instruction set 116 can include adding a note, comment, or other non-executable data to the quantum instruction set 116 descriptive of the annotation. Additionally and/or alternatively, annotating the quantum instruction set 116 can include displaying the annotation (e.g., via the user interface 114) in a proximate relationship with the placeholder quantum resource allocation instruction such that the user is enabled to understand which quantum resource 146 would be allocated by the placeholder quantum resource allocation instruction if the quantum instruction set 116 was queued at the present time. When the user submits the quantum instruction set 116 for execution by the quantum computing systems 141 (e.g., through a submission or confirmation element of the user interface 114), the placeholder quantum resource allocation instruction can be resolved to a properly-formatted allocation instruction based on the quantum resource availability data. For example, the user computing device 110 and/or the classical computing system 120 can further receive (e.g., by the user interface 114 of the quantum development environment 113) a user indication to provide the quantum instruction set 116 for implementation and, based on the user indication, replace the placeholder quantum resource allocation instruction with a second quantum resource allocation instruction that allocates the second quantum resource 146 for implementing the plurality of quantum operation instructions 118.

At 216, the classical computing system 216 can provide the modified quantum instruction set 116 to the quantum computing system 141 for execution. In some cases, the quantum instruction set 116 or portions thereof can be provided to multiple quantum computing systems 141, such as to distribute execution of the quantum instruction set 116 across quantum resources 146 of a plurality of quantum computing systems 141. At 218, the quantum computing system(s) 141 can execute the modified quantum instruction set 116.

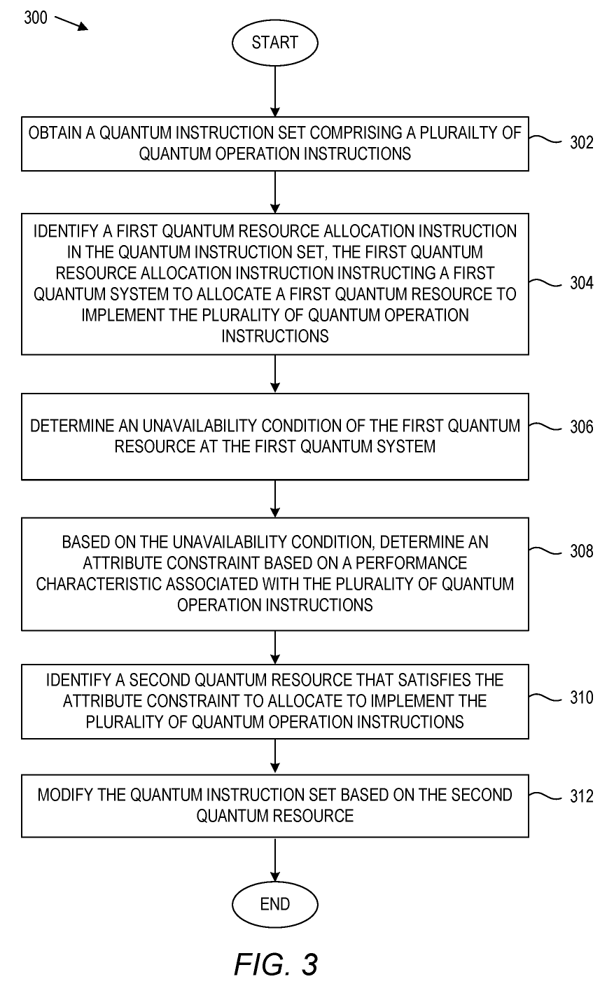

FIG. 3 depicts a flowchart diagram of an example method 300 according to some implementations. At 302, the method 300 includes obtaining a quantum instruction set 116 comprising a plurality of quantum operation instructions 118. At 304, the method 300 includes identifying a first quantum resource allocation instruction in the quantum instruction set 116, the first quantum resource allocation instruction instructing a quantum computing system 141 to allocate a first quantum resource 146 to implement the plurality of quantum operation instructions 118. At 306, the method 300 includes determining an unavailability condition of the first quantum resource 146 at the quantum computing system 141. At 308, the method 300 includes, based on the unavailability condition, determining an attribute constraint based on a performance characteristic associated with the plurality of quantum operation instructions 118. At 310, the method 300 includes identifying a second quantum resource 146 to allocate to implement the plurality of quantum operation instructions 118 that satisfies the attribute constraint. At 312, the method 300 includes modifying the quantum instruction set 116 based on the second quantum resource 146.

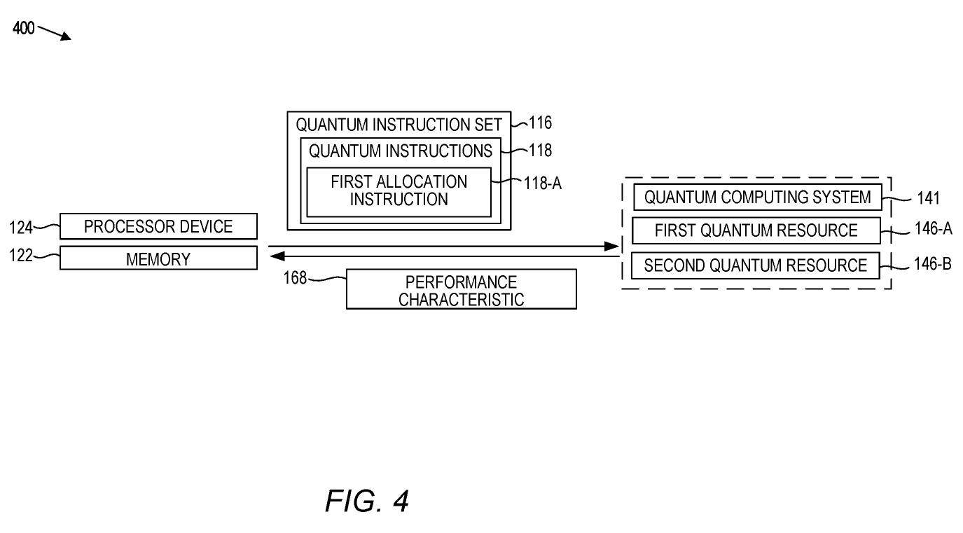

FIG. 4 is a block diagram of an example system 400 according to some implementations. The system 400 includes a processor device 124 and a memory 122 coupled to the processor device 124. The processor device 124 is to obtain a quantum instruction set 116 comprising a plurality of quantum operation instructions 118. The processor device 124 is to identify a first quantum resource allocation instruction in the quantum instruction set 116, the first quantum resource allocation instruction 118-A instructing a quantum computing system 141 to allocate a first quantum resource 146-A to implement the plurality of quantum operation instructions 118. The processor device 124 is to determine an unavailability condition of the first quantum resource 146-A at the quantum computing system 141. The processor device 124 is to, based on the unavailability condition, determine an attribute constraint based on a performance characteristic associated with the plurality of quantum operation instructions 118. The processor device 124 is to identify a second quantum resource 146-B to allocate to implement the plurality of quantum operation instructions 118 that satisfies the attribute constraint. The processor device 124 is to modify the quantum instruction set 116 based on the second quantum resource 146-B.

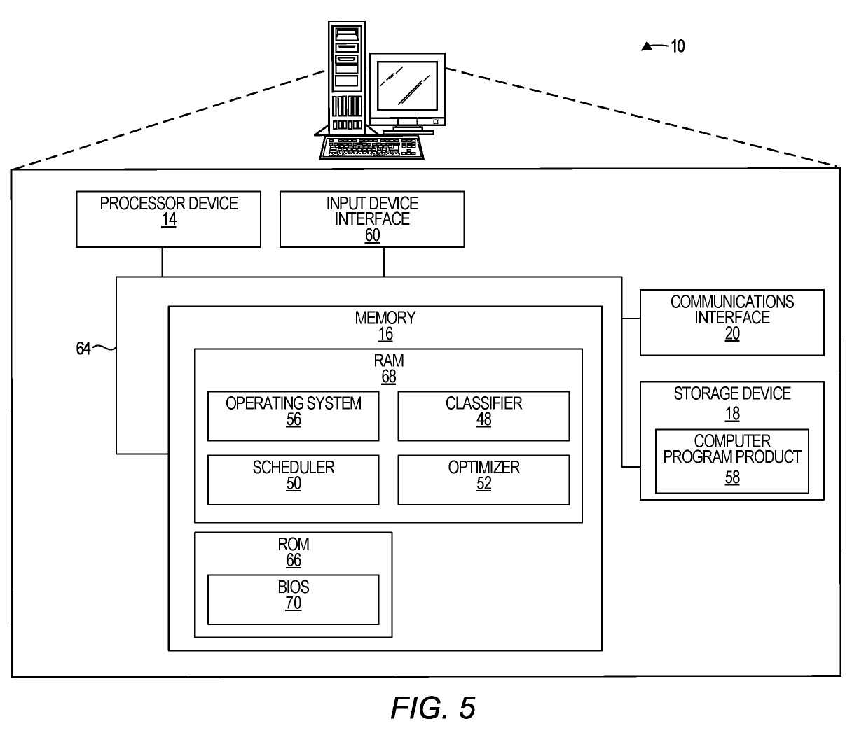

FIG. 5 is a block diagram of a computing device 10 suitable for implementing systems and methods according to one example. The computing device 10 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 10 includes a processor device 14, a system memory 16, and a system bus 64. The system bus 64 provides an interface for system components including, but not limited to, the system memory 16 and the processor device 14. The processor device 14 can be any commercially available or proprietary processor.

The system bus 64 may be any of several types of bus structures that may further interconnect to a memory bus (with or without a memory controller), a peripheral bus, and/or a local bus using any of a variety of commercially available bus architectures. The system memory 16 may include non-volatile memory 66 (e.g., read-only memory (ROM), erasable programmable read-only memory (EPROM), electrically erasable programmable read-only memory (EEPROM), etc.), and volatile memory 68 (e.g., random-access memory (RAM)). A basic input/output system (BIOS) 70 may be stored in the non-volatile memory 66 and can include the basic routines that help to transfer information between elements within the computing device 10. The volatile memory 68 may also include a high-speed RAM, such as static RAM, for caching data.

The computing device 10 may further include or be coupled to a non-transitory computer-readable storage medium such as a storage device 18, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 18 and other drives associated with computer-readable media and computer-usable media may provide non-volatile storage of data, data structures, computer-executable instructions, and the like.

A number of modules can be stored in the storage device 18 and in the volatile memory 68, including an operating system and one or more program modules which may implement the functionality described herein in whole or in part. All or a portion of the examples may be implemented as a computer program product 58 stored on a transitory or non-transitory computer-usable or computer-readable storage medium, such as the storage device 18, which includes complex programming instructions, such as complex computer-readable program code, to cause the processor device 14 to carry out the steps described herein. Thus, the computer-readable program code can comprise software instructions for implementing the functionality of the examples described herein when executed on the processor device 14. The processor device 14, in conjunction with the computer program product 58 in the volatile memory 68, may serve as a controller, or control system, for the computing device 10 that is to implement the functionality described herein.

An operator, such as a user, may also be able to enter one or more configuration commands through a keyboard (not illustrated), a pointing device such as a mouse (not illustrated), or a touch-sensitive surface such as a display device. Such input devices may be connected to the processor device 14 through an input device interface 76 that is coupled to the system bus 64 but can be connected by other interfaces such as a parallel port, an Institute of Electrical and Electronic Engineers (IEEE) 1394 serial port, a Universal Serial Bus (USB) port, an IR interface, and the like. The computing device 10 may also include a communications interface 20, such as an Ethernet transceiver and/or a Wi-Fi transceiver, or the like, suitable for communicating with a network as appropriate or desired. The computing device 10 may also include a video port configured to interface with a display device to provide information to the user.

Individuals will recognize improvements and modifications to the preferred examples of the disclosure. All such improvements and modifications are considered within the scope of the concepts disclosed herein and the claims that follow.

What is claimed is:

1. A method, comprising:
obtaining a quantum instruction set comprising a plurality of quantum operation instructions;
identifying a first quantum resource allocation instruction in the quantum instruction set, the first quantum resource allocation instruction instructing a first quantum computing system to allocate a first quantum resource to implement the plurality of quantum operation instructions;
determining an unavailability condition of the first quantum resource at the first quantum computing system;
based on the unavailability condition, determining an attribute constraint based on a performance characteristic associated with the plurality of quantum operation instructions;
identifying a second quantum resource that satisfies the attribute constraint to allocate to implement the plurality of quantum operation instructions; and
modifying the quantum instruction set based on the second quantum resource.

2. The method of claim 1, wherein the second quantum resource is associated with a second quantum computing system.

3. The method of claim 1, wherein modifying the quantum instruction set based on the second quantum resource comprises:
generating a second quantum resource allocation instruction for the quantum instruction set, wherein the second quantum resource allocation instruction allocates the second quantum resource to implement the plurality of quantum operation instructions; and
replacing the first quantum resource allocation instruction with the second quantum resource allocation instruction.

4. The method of claim 1, wherein the unavailability condition of the first quantum resource is determined based on quantum resource availability data obtained from a quantum resource registry at the first quantum computing system.

5. The method of claim 4, further comprising displaying, in a user interface of a quantum development environment, the quantum instruction set annotated with the quantum resource availability data obtained from the quantum resource registry.

6. The method of claim 5, wherein identifying the second quantum resource comprises receiving, by a resource selection element of the user interface of the quantum development environment, a user selection of the second quantum resource.

7. The method of claim 5, wherein modifying the quantum instruction set based on the second quantum resource comprises:
generating a placeholder quantum resource allocation instruction;
replacing the first quantum resource allocation instruction with the placeholder quantum resource allocation instruction;
generating an annotation indicative of the second quantum resource; and
annotating the quantum instruction set with the annotation respective to the placeholder quantum resource allocation instruction.

8. The method of claim 7, further comprising:
receiving, by the user interface of the quantum development environment, a user indication to provide the quantum instruction set for implementation; and
based on the user indication, replacing the placeholder quantum resource allocation instruction with a second quantum resource allocation instruction that allocates the second quantum resource to implement the plurality of quantum operation instructions.

9. The method of claim 1, wherein the quantum instruction set further comprises an additional quantum resource allocation instruction instructing the first quantum computing system to allocate a first additional quantum resource to implement the plurality of quantum operation instructions.

10. The method of claim 9, wherein the plurality of quantum operation instructions comprises a quantum gate operation that is implemented by both the first quantum resource and the first additional quantum resource.

11. The method of claim 9, wherein the attribute constraint comprises a proximity constraint on a relative position of the first additional quantum resource and the first quantum resource.

12. The method of claim 11, wherein identifying the second quantum resource comprises:
determining that a combination of the second quantum resource and a second additional quantum resource satisfies the proximity constraint; and
based on determining that the combination of the second quantum resource and the second additional quantum resource satisfies the proximity constraint, identifying the second quantum resource to replace the first quantum resource.

13. The method of claim 9, wherein the performance characteristic comprises a latency of the first quantum computing system associated with a proximity of the first quantum resource and the first additional quantum resource.

14. The method of claim 1, wherein the quantum instruction set comprises a Quantum Assembly (QASM) file.

15. The method of claim 1, wherein the first quantum resource and the second quantum resource comprise qubits of the first quantum computing system.

16. The method of claim 1, wherein the attribute constraint specifies one or more of a material, a type, a configuration, or an operational parameter.

17. The method of claim 1, wherein the performance characteristic comprises expected performance data of the plurality of quantum operation instructions respective to an attribute of the attribute constraint, the expected performance data learned from historical usage data associated with the first quantum computing system.

18. A computing system, comprising:
a memory; and
a processor device coupled to the memory to:
obtain a quantum instruction set comprising a plurality of quantum operation instructions;
identify a first quantum resource allocation instruction in the quantum instruction set, the first quantum resource allocation instruction instructing a first quantum computing system to allocate a first quantum resource to implement the plurality of quantum operation instructions;
determine an unavailability condition of the first quantum resource at the first quantum computing system;
based on the unavailability condition, determine an attribute constraint based on a performance characteristic associated with the plurality of quantum operation instructions;
identify a second quantum resource that satisfies the attribute constraint to allocate to implement the plurality of quantum operation instructions; and
modify the quantum instruction set based on the second quantum resource.

19. The computing system of claim 18, wherein, to modify the quantum instruction set based on the second quantum resource, the processor device is further to:
generate a second quantum resource allocation instruction for the quantum instruction set, wherein the second quantum resource allocation instruction allocates the second quantum resource to implement the plurality of quantum operation instructions; and
replace the first quantum resource allocation instruction with the second quantum resource allocation instruction.

20. A non-transitory computer-readable storage medium that includes executable instructions to cause a processor device to:
obtain a quantum instruction set comprising a plurality of quantum operation instructions;
identify a first quantum resource allocation instruction in the quantum instruction set, the first quantum resource allocation instruction instructing a first quantum computing system to allocate a first quantum resource to implement the plurality of quantum operation instructions;
determine an unavailability condition of the first quantum resource at the first quantum computing system;
based on the unavailability condition, determine an attribute constraint based on a performance characteristic associated with the plurality of quantum operation instructions;
identify a second quantum resource that satisfies the attribute constraint to allocate to implement the plurality of quantum operation instructions; and
modify the quantum instruction set based on the second quantum resource.
